(19) United States
(12) Patent Application Publication
(10) Pub. No.: US 2007/0143540 A1
(43) Pub. Date: Jun. 21, 2007

(54) RAID setting system having scanning module and related method

(75) Inventors: Chen Pin Lee, Taipei (TW); Margaret Chen, Taipei (TW); Fei Wen Chen, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/303,379

(22) Filed: Dec. 16, 2005

(51) Int. Cl. G06F 12/16

(52) U.S. Cl. 711/114

(57) ABSTRACT

A RAID setting system and related method are used in a computer having at least a RAID controller for controlling the RAID controller to execute a corresponding operation of the RAID configuration according to a setting result. The system includes a database, a detecting module, a setting module and a processing module. The method includes storing operating flow data of a RAID configuration corresponding to the RAID controller in a database, scanning the RAID controller connected in the computer to select a specified RAID controller, providing a setting interface which can set parameters for the RAID configuration corresponding to the RAID controller, and invoking an operating flow data of the RAID controller according to a setting result so as to control the RAID controller to execute a corresponding operation of the RAID configuration. A setting operation of the RAID can be simplified and working efficiency can be enhanced as well.

### BACKGROUND OF THE INVENTION

1. Field of the Invention

The present invention relates to an interface setting technique and, more particularly to a redundant array of independent disks (RAID) setting system having scanning module and method thereof.

2. Description of Related Art

In recent years, a network server is allowed to function with various data storage systems, and a RAID system is one of the most popular data storage system at present.

A typical data storage system comprises a plurality of Disks, which are configured by a plurality of RAID levels. A RAID controller is a device for managing one or more RAIDs. The RAID controller is in charge of configuration setting on each of the Disks of the data storage system to form a corresponding logical Disk, and selecting one of the RAID levels to manage the logical Disk.

However, a setting operation of the RAID controller is very complicated in the prior art, so it is difficult for a user without sufficient enough expertise in this art. The main reasons are described as follows:

(1) The user has to press a Hotkey predefined by the manufacturer at a specific time after the computer is just powered on to enter a setting interface of the RAID. If the user does not press the Hotkey until the specific time has passed or hasn't pressed the correct Hotkey, the computer must be restarted and the above step should be repeated;

(2) The setting interface of a traditional RAID is a Text Window interface which may be inputted only by keyboard, so it is not convenient;

(3) The operation flows of the RAID configuration provided by manufacturers are different. For instance, the RAID setting flow designed by ADAPTEC is firstly initializing the Disk, and then setting related parameters of the RAID; whereas the RAID setting flow designed by LSI is firstly setting related parameters of the RAID, and then initializing the Disk. Accordingly, when a user accustomed to the ADAPTEC setting flow sets the LSI RAID controller, he may forget to initialize the Disk after setting related parameters of the RAID, thereby the RAID configuration can not be completed successfully; and

(4) The computer must be restarted after setting the RAID. However it is a waste of time.

As a result, the present subject to be solved is to provide a RAID setting method in order to overcome the problems of the prior art.

### SUMMARY OF THE INVENTION

In views of the above-mentioned problems, it is a primary objective of the present invention to provide a RAID setting system and method thereof which can integrate setting interfaces of RAID controllers designed by different manufacturers, so as to make the operation more convenient for a user.

It is another objective of the present invention to provide a RAID setting system and method thereof which can automatically execute a corresponding operation of the RAID configuration according to a setting result of the user without manual operation, such that the validity of the RAID configuration operation can be increased.

It is a further objective of the present invention to provide a RAID setting system and method thereof which can automatically load and install a driver corresponding to the RAID controller.

It is still another objective of the present invention to provide a RAID setting system and method thereof for saving setting time as it needs not restart the computer after setting the RAID.

To achieve the above-mentioned and other objectives, a RAID setting system and method thereof are provided in the present invention. The RAID setting system is used in a computer having at least a RAID controller for controlling the RAID controller to execute a corresponding operation of the RAID configuration according to a setting result. The RAID setting system includes a database for storing operating flow data of a RAID configuration corresponding to the RAID controller, a detecting module for scanning the RAID controllers connected in the computer such that a user can select a specified RAID controller, a setting module for providing a setting interface which can set parameters for the RAID configuration corresponding to the RAID controller, and a processing module for invoking an operating flow data of the RAID controller from the database according to the parameters set by the setting interface of the setting module, so as to control the RAID controller to execute a corresponding operation of the RAID configuration.

The RAID setting method is also used in a computer having at least a RAID controller for controlling the RAID controller to execute a corresponding operation of the RAID configuration according to a setting result. The RAID setting method includes storing operating flow data of a RAID configuration corresponding to the RAID controller in a database, scanning the RAID controllers connected in the computer for a user to select a specified RAID controller, providing a setting interface which can set parameters for the RAID configuration corresponding to the RAID controller, and invoking an operating flow data of the RAID controller according to the parameters, so as to control the RAID controller to execute a corresponding operation of the RAID configuration.

Compared to the prior art, the RAID setting system and method thereof of the present invention can integrate setting interfaces of RAID controllers designed by different manufacturers and provide a uniform operation interface for a user to automatically execute a RAID configuration operation according to a setting result. Furthermore, a driver of the RAID controller can be loaded and installed automatically during the OS (Operation System) is started up. Therefore, the problems of the prior art such as a waste of time, low working efficiency and complexity in installing the driver can be solved effectively.

### BRIEF DESCRIPTIONS OF THE DRAWINGS

FIG. 1 is a block diagram showing a basic structure of a RAID setting system according to the present invention; and

FIG. 2 is a flow chart showing a basic operating flow of a RAID setting method according to the present invention.

### DETAILED DESCRIPTIONS OF PREFERRED EMBODIMENTS

The following specific embodiment is provided to illustrate the disclosure of the present invention, these and other advantages and effects can be apparently understood by those in the art after reading the disclosure of this specification. The present invention can also be performed or applied by other different embodiments.

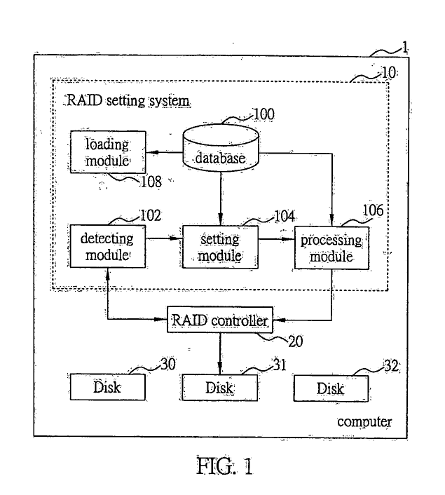

FIG. 1 is a block diagram showing a basic structure of a RAID setting system 10 according to the present invention. As shown in FIG. 1, the RAID setting system 10 is used in a computer 1 having at least a RAID controller 20. The system 10 is used to control the RAID controller 20 to execute a corresponding operation of the RAID configuration according to a setting result (parameters) set by a user. In the present embodiment, the RAID controller 20 is connected to the computer 1 through a Peripheral Component Interface (PCI).

As shown in FIG. 1, the RAID setting system 10 of the present invention comprises a database 100, a detecting module 102, a setting module 104, a processing module 106 and a loading module 108. Operating flow data of the RAID configuration corresponding to the RAID controllers 20 are stored in the database 100. In the present embodiment, the operating flow data refer to RAID setting programs provided by RAID manufacturers (it will be described thereafter). Furthermore, the database 100 further stores Application Programming Interface (API), related tool programs and driver program data of the RAID controllers 20.

The detecting module 102 is used to automatically scan the RAID controllers 20 connected to the computer 1 at a specific time after the computer is powered on. In this embodiment, the detecting module 102 scans the PCI of the computer 1 to get PCI ID of each RAID controller 20 and interprets trade marks and types of the RAID controller 20 according to the PCI ID. Then the interpreted trade marks and types of the RAID controller 20 are displayed line by line on a screen (not shown in the figure) of the computer 1, such that the user can select a specified RAID controller 20 in accordance with a practical demand.

The setting module 104 is used to provide a setting interface for the user to set parameters for the RAID configuration corresponding to the RAID controller 20. In this embodiment, the setting module 104 invokes API from the database 100 in accordance with the RAID controller 20 selected by the user, reads related information from Disks 30, 31 and 32, all of which are connected to the RAID controller 20, and then provides a setting interface for a user to set corresponding parameters for the RAID configuration. The parameters for the RAID configuration comprise selecting Disks to form the RAID from the Disks 30, 31 and 32, setting a RAID Level parameter of the RAID to be formed, and setting a Hot Spare Disk of the RAID. The setting interface of the present invention only provides basic functions of the RAID controller 20, and other setting functions (for example, the synchronous operation between the Disks) can be manually set by the user in accordance with practical demands. As these setting functions are prior art, they are not illustrated herein.

The processing module 106 is used to invoke one of the operating flow data of the RAID controller 20 from the database 100 according to the parameters set by the setting interface of the setting module 104 so as to control the RAID controller 20 to execute a corresponding operation of the RAID configuration. Since the setting operation flows of the RAID provided by manufacturers are different from one another, accordingly the processing module 106 may find out corresponding setting flows in accordance with the ID of the Disks 30, 31 and 32 of the detected RAID controller 20, and execute the corresponding process to the Disks 30, 31 and 32. For example, if the setting flow of the Disks 30, 31 and 32 is firstly initializing the Disk and then setting related parameters of the RAID, the Disks 30, 31 and 32 are automatically initialized before the setting module 104 provides the setting interface for the user to set related parameters of the RAID; on the other hand, if the setting flow of the Disks 30, 31 and 32 is firstly setting related parameters of the RAID, and then initializing the Disk, the Disks 30, 31 and 32 are automatically initialized after the setting module 104 provides the setting interface for the user to set related parameters of the RAID; such that the RAID configuration can be completed successfully.

The loading module 108 is used to search an appropriate driver for the RAID controller 20 from the database 100, and then automatically load and install the driver to complete the OS installation successfully.

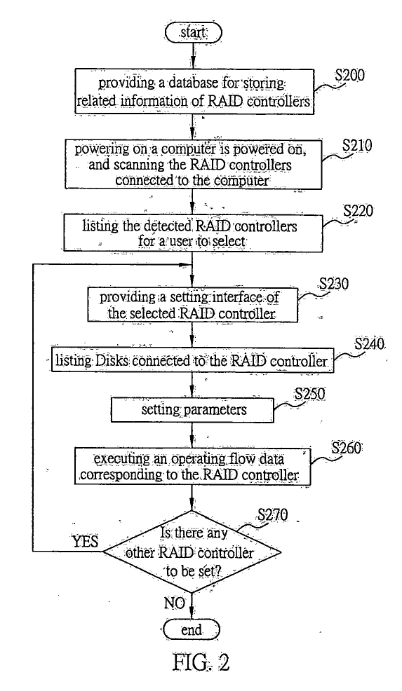

FIG. 2 is a flow chart showing a basic operating flow of a RAID setting method according to the present invention. The RAID setting method is used in a computer having at least a RAID controller in the present embodiment. As shown in the FIG. 2, a database 100 is provided in step S200 for storing operating flow data of RAID configurations corresponding to the RAID controllers 20, API or related tool programs and driver program data of the RAID controllers 20. Then go to step S210.

In step S210, the PCI of the computer 1 are automatically scanned at a specific time after the computer is powered on, and the PCI ID of each RAID controller 20 in the computer is detected. Then execute step S220.

In step S220, the detected RAID controllers 20 are listed, so the user can select specified RAID controllers 20. Then go to step S230.

In step S230, a setting interface of the selected RAID controller 20 is provided. Then execute step S240.

In step S240, the API of the RAID controller 20 in invoked to read and display the related information of the Disks 30, 31, 32 connected to the RAID controller 20. The execute step S250.

In step S250, the parameters for the RAID configuration of the RAID controller 20 are set. The parameters include: selecting Disks to form the RAID from the Disks 30, 31 and 32; setting a RAID Level parameter of the RAID to be formed; and setting a Hot Spare Disk of the RAID. Then go to step S260.

In step S260, one of the operating flow data corresponding to the RAID controller 20 is invoked from the database 100 according to the parameters set in step S250, so the control the RAID controller 20 is controlled to execute the corresponding operation of the RAID configuration. Then go to step S270.

In step S270, whether there is other RAID controller 20 to be set is determined. Return to step S230 if the answer is yes; otherwise complete the operation flow.

Moreover, the RAID setting method of the present invention further comprises reading the driver program data of the RAID controller 20 for automatically loading and installing the driver program data when the computer 1 boots up the OS.

As a result, the present invention provides the following functions: firstly, setting interfaces of the RAID controllers 20 designed by different manufacturers are integrated and a uniform setting interface is provided to the user for convenient operation; secondly, the corresponding RAID configuration operation is executed automatically according to the related parameters for the RAID configuration set by the user without manual operation of the prior art, such that not only the RAID configuration operation is more convenient, but also the working efficiency is enhanced; furthermore, the driver of the RAID controller 20 is automatically loaded and installed after the configuration operation, so that the flow of installing the OS of the computer is simplified; moreover, it needs not restart the computer after setting the RAID configuration, and the setting interface is automatically provided without manual operation at a specific time after the computer is powered on, thereby time and manpower can be saved effectively.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A redundant array of independent disks (RAID) setting system which is used in a computer having at least a RAID controller, the RAID setting system comprising:
a database for storing operating flow data of a RAID configuration corresponding to the RAID controller;
a detecting module for scanning the RAID controller connected in the computer, such that a user can select a specified RAID controller;
a setting module for providing a setting interface which can set parameters for the RAID configuration corresponding to the RAID controller; and
a processing module for invoking one of the operating flow data of the RAID controller according to the parameters set by the setting interface of the setting module, so as to control the RAID controller to execute a corresponding operation of the RAID configuration.

2. The RAID setting system of claim 1, wherein the detecting module automatically executes the scanning operation at a specific time after the computer is powered on.

3. The RAID setting system of claim 1, wherein the database further comprises application programming interface (API) data in accordance with the RAID controller.

4. The RAID setting system of claim 1, wherein the setting module invokes API in accordance with the RAID controller and reads related information of disks which are connected to the RAID controller for a user to set corresponding parameters for the RAID configuration.

5. The RAID setting system of claim 1, wherein the parameters for the RAID configuration at least comprise a RAID Level parameter, a configuration parameter of a Disk composing the RAID Level and a configuration parameter for one of Hot Spare Disks.

6. The RAID setting system of claim 1 further comprising a loading module for loading a driver of the RAID controller and automatically installing the driver when the computer boots up an operating system (OS).

7. A RAID setting method, which is used in a computer having at least a RAID controller, the RAID setting method comprising:
storing operating flow data of a RAID configuration corresponding to the RAID controller in a database;
scanning the RAID controller connected in the computer for a user to select a specified RAID controller;
providing a setting interface which can set parameters for the RAID configuration corresponding to the RAID controller; and
invoking one of the operating flow data of the RAID controller according to the parameters set by the setting interface, so as to control the RAID controller to execute a corresponding operation of the RAID configuration.

8. The RAID setting method of claim 7, wherein the RAID controller in the computer is automatically scanned at a specific time after the computer is powered on.

9. The RAID setting method of claim 7, wherein the database further comprises API data in accordance with the RAID controller.
